(19) United States
(12) Patent Application Publication
(10) Pub. No.: US 2023/0352670 A1
(43) Pub. Date: Nov. 2, 2023

(54) CATHODE MATERIAL FOR LITHIUM SECONDARY BATTERY AND METHOD FOR MANUFACTURING THE CATHODE MATERIAL

(71) Applicants: Hyundai Motor Company, Seoul (KR); Kia Corporation, Seoul (KR); Industry Academy Cooperation Foundation of Sejong University, Seoul (KR)

(72) Inventors: Seung Min Oh, Incheon (KR); Sung Ho Ban, Hwaseong (KR); Sang Hun Lee, Paju (KR); Yoon Sung Lee, Suwon (KR); Chang Hoon Song, Seoul (KR); Seung Taek Myung, Seoul (KR); Hee Jae Kim, Seoul (KR); Min Young Shin, Seoul (KR); Jun Ho Yu, Seoul (KR); Woo Young Jin, Busan (KR)

(21) Appl. No.: 17/973,780

(22) Filed: Oct. 26, 2022

(30) Foreign Application Priority Data
Apr. 29, 2022 (KR) 10-2022-0053787

(51) Int. Cl. H01M 4/505; H01M 4/485; H01M 4/04

(52) U.S. Cl. CPC H01M 4/505; H01M 4/485; H01M 4/0471

(57) ABSTRACT

Disclosed are a cathode material for a lithium secondary battery, which improves air exposure stability while having high energy density with a single cathode material, and a method for manufacturing the cathode material. The cathode material includes a Li—[Mn—Ti]—Al—O-based cathode active material and a carbon coating layer including pitch carbon and coated on a surface of the cathode active material.

### CROSS REFERENCE TO RELATED APPLICATION

The present application claims priority to Korean Patent Application No. 10-2022-0053787, filed Apr. 29, 2022, the entire contents of which is incorporated herein for all purposes by this reference.

### TECHNICAL FIELD

The present invention relates to a cathode material for a lithium secondary battery and a method for manufacturing the cathode material. The cathode material for a lithium secondary battery may improve air exposure stability while having high energy density merely with a single cathode material.

### BACKGROUND OF THE INVENTION

Secondary batteries have been used as small and high-performance energy storage devices in portable electronic devices such as portable phones, camcorders, laptop computers, etc. For miniaturization of portable electronic devices and continuous use thereof for a long time, there is a need for a secondary battery capable of realizing small size and high capacity along with research on weight reduction and low power consumption of parts.

In addition, recently, the use range of secondary batteries has been expanded to medium and large energy storage devices such as electric vehicles (EVs) beyond small energy storage devices.

In particular, a lithium secondary battery that is a representative secondary battery has greater energy density, larger capacity per area, lower self-discharge rate, and longer lifetime than a nickel manganese battery or a nickel cadmium battery. Because of no memory effect, characteristics of convenience in use and long lifetime may be provided.

For a lithium secondary battery, electric energy is produced, e.g., by oxidation and reduction reactions when lithium ions are intercalated/deintercalated in a cathode and an anode in a state where an electrolyte is charged between the cathode and the anode that are composed of active materials into and from which the lithium ions may be intercalated and deintercalated.

Such a lithium secondary battery includes a cathode material, an electrolyte, a separator, an anode material, and the like and it is very important to stably maintain an interfacial reaction between components so as to secure long lifetime and reliability of the lithium secondary battery.

To improve the performance of the lithium secondary battery, study to improve the cathode material has been steadily carried out.

In particular, a lot of research has been conducted to develop a high-performance and high-stability lithium secondary battery, but as the explosion accident of the lithium secondary battery has frequently occurred, safety issues are being constantly raised.

Moreover, the cathode material containing 80% or greater of nickel with high energy density in a candidate group of the cathode materials is very sensitive in the air and is not easy to synthesize.

While electrochemical performance has been enhanced by doping transition metal in a cathode active material or optimizing a composition of the transition metal, and durability and output have been optimized through conductive carbon coating such as a carbon nanotube (CNT), there is still uncertainty about safety of exposure to the air, making actual application to a lithium secondary battery.

The matters described as the background art are merely for understanding the background of the present invention, and should not be accepted as acknowledging that they correspond to the prior art known to those of ordinary skill in the art.

### SUMMARY OF THE INVENTION

In preferred aspects, provided are a cathode material for a lithium secondary battery, which has high energy density merely by coating a proper amount of pitch carbon on a surface of a cathode active material, and a method for manufacturing the cathode material. For example, when a lithium rich material is used, a high capacity of 250 mAh/g or greater may be implemented in a voltage range of 2-4.2V and stability of exposure to the air may be improved when a cathode material surface is covered through pitch carbon coating.

Also provided are a cathode material for a lithium secondary battery, which improves air exposure stability, and a method for manufacturing the cathode material.

Technical problems to be solved in the present invention are not limited to the above-mentioned technical problems, and other unmentioned technical problems may be clearly understood by those skilled in the art from the description of the present invention.

In one aspect, provided is cathode material that may include a Li—[Mn—Ti]—Al—O-based cathode active material and a carbon coating layer including pitch carbon and coated on a surface of the cathode active material. Particularly, the carbon coating layer may include an amount of about 2.5 to 10 wt % of pitch carbon with respect to 100 wt % of the cathode active material as being coated on the surface of the cathode active material.

A term “pitch carbon” as used herein refers to a carbon material mainly including aromatic hydrocarbons.

The cathode active material may include Li_{1.25+y}[Mn_{0.45}Ti_{0.35}]₁₋ₓAlₓO₂, in which 0.025≤x≤0.05 and −0.02≤y≤0.02 are satisfied.

The cathode active material may suitably include Li_{1.25}[Mn_{0.45}Ti_{0.35}]_{0.975}Al_{0.025}O₂.

A thickness of the carbon coating layer may be of about 10 to 25 nm.

The cathode material may further include a metal oxide coating layer in which an Li—Mo—O-based coating material is coated on the surface of the cathode active material.

The metal oxide coating layer may be coated on the surface of the cathode active material in a form of an island, and the carbon coating layer may be coated on the surface of the cathode active material in a shape of an island, or may be coated on the surface of the cathode active material and a surface of the metal oxide coating layer in a form of a layer.

The cathode active material does not include Ni nor Co.

In one aspect, provided is a method for manufacturing a cathode material for a lithium secondary battery. The method may include steps of: preparing an Li—[Mn—Ti]—Al—O-based cathode active material and forming a carbon coating layer by coating pitch carbon on a surface of the cathode active material.

The cathode active material may be prepared by steps including: forming an admixture including Li₂CO₃, Mn₂O₃, TiO₂, and Al₂O₃ in an anhydrous ethanol and process the admixture by using a ball milling, cleaning, drying and pelletizing the processed admixture, and calcinating the pelletized admixture in an inert atmosphere to obtain the powder.

The admixture may include Li_{1.25+y}[Mn_{0.45}Ti_{0.35}]₁₋ₓAlₓO₂, in which 0.025≤x≤0.05 and −0.02≤y≤0.02 are satisfied.

The admixture may include Li_{1.25}[Mn_{0.45}Ti_{0.35}]_{0.975}Al_{0.025}O₂.

The ball milling process may be carried out by blending a plurality of ZrO₂ balls having different diameters in a mixed solution in which Li₂CO₃, Mn₂O₃, TiO₂, and Al₂O₃ are mixed in anhydrous ethanol.

For example, a mixed solution may be prepared by mixing the admixture including, e.g., Li₂CO₃ (4.2341 g), Mn₂O₃ (3.2086 g), TiO₂ (2.5387 g), and Al₂O₃ (0.11883 g) in 80 ml of anhydrous ethanol, and the ball milling process may be carried out in 17 sets of about 15 minutes each at about 300 rpm/5 h, by mixing a ZrO₂ ball having a diameter of 10 mm, mixing 20 g of a ZrO₂ ball having a diameter of 5 mm, and mixing 8 g of a ZrO₂ ball having a diameter of 1 mm.

In the calcinating the pelletized admixture, the admixture may be heated for about 10 to 14 hours at a temperature of about 850 to 950° C.

The method may further include, before forming the carbon coating layer, forming a metal oxide coating layer in which an Li—Mo—O-based coating material is coated on the surface of the cathode active material.

The forming metal oxide coating layer may include mixing an amount of about 2 to 3 wt % of an Na₂MoO₄ material with respect to 100 wt % of the cathode active material and heating a mixture for about 3 to 5 hours at a temperature of about 250 to 350° C.

The forming metal oxide coating layer may include performing heating in an inert or reducing atmosphere.

The forming the carbon coating layer may include mixing an amount of about 2.5 to 10 wt % of pitch carbon with respect to 100 wt % of the cathode active material and heating a mixture for about 3 to 5 hours at a temperature of about 250 to 350° C.

The forming carbon coating layer may include performing heating in an inert or reducing atmosphere.

According to various exemplary embodiments of the present invention, coating the pitch carbon with the single cathode material may be sufficient to provide the cathode material having high energy density.

In particular, by coating the pitch carbon on the Li—[Mn—Ti]—Al—O-based cathode active material, the structural stability and the electrochemical characteristics of the cathode material may be improved, thereby enhancing air exposure safety.

Therefore, a pure electric vehicle model may be established, and a manufacturing cost of a battery-centered pure electric vehicle may be reduced when compared to hybrid and derivative electric vehicles of a type in which a driving device is placed on an existing designed vehicle structure.

### BRIEF DESCRIPTION OF THE DRAWINGS

FIG. 1 shows an XRD result of a cathode material for a lithium secondary battery, according to an exemplary embodiment of the present invention;

FIG. 2 shows a SEM image of a cathode material for a lithium secondary battery, according to an exemplary embodiment of the present invention;

FIG. 3 shows a TEM image of a cathode material for a lithium secondary battery, according to an exemplary embodiment of the present invention;

FIGS. 4 to 7 are graphs showing results of evaluating electrochemical characteristics of a cathode material according to a comparative example, an embodiment 1, an embodiment 2, and an embodiment 3, respectively;

FIGS. 8 to 15 are graphs showing results of evaluating electrochemical characteristics of a cathode material in which Comparative Example and Embodiment 1 are exposed to the air for 1 hour, 5 hours, 10 hours, and 24 hours, respectively; and

FIGS. 16 to 23 are graphs showing results of evaluating electrochemical characteristics of a cathode material in which Comparative Example and Embodiment 1 are exposed to the air for 1 hour, 5 hours, 10 hours, and 24 hours, and are then dried respectively.

### DETAILED DESCRIPTION

Hereinafter, embodiments of the present invention will be described in more detail with reference to the accompanying drawings. However, the present disclosure is not limited to the disclosed embodiments, but may be implemented in various manners, and the embodiments are provided to complete the disclosure of the present disclosure and to allow those of ordinary skill in the art to understand the scope of the present disclosure.

Like reference numbers refer to like elements throughout the description of the figures. In the drawings, the sizes of structures may be exaggerated for clarity. It will be understood that, although the terms “first”, “second”, etc. may be used herein to describe various elements, these elements should not be construed as being limited by these terms, which are used only to distinguish one element from another. For example, within the scope defined by the present invention, a “first” element may be referred to as a “second” element, and similarly, a “second” element may be referred to as a “first” element. Singular forms are intended to encompass the plural meaning as well, unless the context clearly indicates otherwise.

It will be further understood that terms such as “comprise” or “has”, when used in this specification, specify the presence of stated features, integers, steps, operations, elements, components or combinations thereof, but do not preclude the presence or addition of one or more other features, integers, steps, operations, elements, components, or combinations thereof. In addition, it will be understood that, when an element such as a layer, film, region or substrate is referred to as being “on” another element, it can be directly on the other element, or an intervening element may also be present. It will also be understood that when an element such as a layer, film, region or substrate is referred to as being “under” another element, it can be directly under the other element, or an intervening element may also be present.

Unless the context clearly indicates otherwise, all numbers, figures, and/or expressions that represent ingredients, reaction conditions, polymer compositions, and amounts of mixtures used in the specification are approximations that reflect various uncertainties of measurement occurring inherently in obtaining these figures, among other things. For this reason, it should be understood that, in all cases, the term “about” should be understood to modify all such numbers, figures and/or expressions. Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In addition, when numerical ranges are disclosed in the description, these ranges are continuous, and include all numbers from the minimum to the maximum, including the maximum within each range, unless otherwise defined. Furthermore, when the range refers to an integer, it includes all integers from the minimum to the maximum, including the maximum within the range, unless otherwise defined.

It should be understood that, in the specification, when a range is referred to regarding a parameter, the parameter encompasses all figures including end points disclosed within the range. For example, the range of “5 to 10” includes figures of 5, 6, 7, 8, 9, and 10, as well as arbitrary sub-ranges, such as ranges of 6 to 10, 7 to 10, 6 to 9, and 7 to 9, and any figures, such as 5.5, 6.5, 7.5, 5.5 to 8.5, and 6.5 to 9, between appropriate integers that fall within the range. In addition, for example, the range of “10% to 30%” encompasses all integers that include numbers such as 10%, 11%, 12%, and 13%, as well as 30%, and any sub-ranges, such as 10% to 15%, 12% to 18%, or 20% to 30%, as well as any numbers, such as 10.5%, 15.5%, and 25.5%, between appropriate integers that fall within the range.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

A cathode material for a lithium secondary battery according to an exemplary embodiment of the present invention is a material forming a cathode applied to the lithium secondary battery, and is formed by coating pitch carbon on a surface of a cathode active material.

Preferably, the cathode material includes a Li—[Mn—Ti]—Al—O-based cathode active material and a carbon coating layer formed by coating the pitch carbon on the surface of the cathode active material.

The lithium secondary battery according to an exemplary embodiment of the present invention may include a cathode including a cathode active material coated with pitch carbon, an anode including an anode active material, and an electrolyte.

The cathode active material may include an Li—[Mn—Ti]—Al—O-based material to allow reversible intercalations and deintercalations of lithium ions.

In this case, the cathode active material may include Li_{1.25+y}[Mn_{0.45}Ti_{0.35}]₁₋ₓAlₓO₂, in which 0.025≤x≤0.05 and −0.02≤y≤0.02 are satisfied.

In particular, the cathode active material may not include Ni nor Co.

For example, the cathode active material may include Li_{1.25}[Mn_{0.45}Ti_{0.35}]_{0.975}Al_{0.025}O₂.

Preferably, an atomic ratio of Mn and Ti, and a molar ratio of Li, Al and O may be determined as Li_{1.25}[Mn_{0.45}Ti_{0.35}]_{0.975}Al_{0.025}O₂ to secure a high reversible capacity and maintain superior lifetime characteristics.

The carbon coating layer may be formed by coating the pitch carbon on the surface of the cathode active material. The pitch carbon coated on the surface of the cathode active material may be a means for improving safety when the cathode active material is exposed to the air.

When the carbon coating layer, i.e., pitch carbon is coated to the cathode active material, the surface of the cathode active material may be protected by being covered with the carbon coating layer. Moreover, even when the cathode active material is exposed to external moisture, the moisture is prevented from affecting the cathode active material by reacting a functional group of the pitch carbon forming the carbon coating layer, thereby improving air exposure safety of the cathode active material.

In this case, the carbon coating on the surface of the cathode active material may be formed by coating an amount of about 2.5 to 10 wt % of pitch carbon with respect to 100 wt % of the cathode active material.

In particular, a thickness of the carbon coating layer may be about 10 to 25 nm.

The cathode active material according to an exemplary embodiment of the present invention may further include a metal oxide coating layer in which an Li—Mo—O-based coating material is coated on the surface of the cathode active material.

In this case, the metal oxide coating layer may be coated to reform the surface of the cathode active material.

For example, the metal oxide coating layer may be LiₐMoO_{b}, and preferably, satisfy 0≤a≤6 and 2≤b≤4.

The metal oxide coating layer may be coated in an amount of about 0.1 to 10 wt % with respect to 100 wt % of the cathode active material.

In this case, the metal oxide coating layer may be coated on the surface of the cathode active material in a form of an island.

As such, since the metal oxide coating layer may be coated on the surface of the cathode active material in a form of an island, the carbon coating layer formed after formation of the metal oxide coating layer may be coated on the surface of the cathode active material in a shape of an island, or may be coated on the surface of the cathode active material and a surface of the metal oxide coating layer in a form of a layer.

A method for manufacturing the cathode material formed as described will be described.

A method for manufacturing a cathode material for a lithium secondary battery according to an exemplary embodiment of the present invention may include steps of: preparing a cathode active material and forming a carbon coating layer on a surface of the cathode active material.

The method may further include, before the forming the carbon coating layer, forming a metal oxide coating layer on the surface of the cathode active material.

The cathode active material may be prepared by using an Li—[Mn—Ti]—Al—O-based material.

In addition, the preparing for the cathode active material may first include preparing the Li—[Mn—Ti]—Al—O-based material.

The preparing for the cathode active material may include a process of mixing Li₂CO₃, Mn₂O₃, TiO₂, and Al₂O₃ in an anhydrous ethanol and synthesizing them using a ball milling process.

The ball milling process performed in the synthesizing process may be carried out by blending a plurality of ZrO₂ balls having different diameters in a mixed solution in which the admixture including Li₂CO₃, Mn₂O₃, TiO₂, and Al₂O₃ are mixed in anhydrous ethanol.

For example, the mixed solution may be prepared by mixing Li₂CO₃ (4.2341 g), Mn₂O₃ (3.2086 g), TiO₂ (2.5387 g), and Al₂O₃ (0.11883 g) in 80 ml of anhydrous ethanol.

The ball milling process may be carried out in 17 sets of about 15 minutes each at about 300 rpm/5 h, by mixing about 10 g of a ZrO₂ ball having a diameter of about 10 mm, mixing about 20 g of a ZrO₂ ball having a diameter of about 5 mm, and mixing about 8 g of a ZrO₂ ball having a diameter of about 1 mm.

The Li—[Mn—Ti]—Al—O-based material synthesized in the synthesizing process may include Li_{1.25+y}[Mn_{0.45}Ti_{0.35}]₁₋ₓAlₓO₂, in which 0.025≤x≤0.05 and −0.02≤y≤0.02 are satisfied. For example, the admixture may include Li_{1.25}[Mn_{0.45}Ti_{0.35}]_{0.975}Al_{0.025}O₂. The synthetic product provided in this way may not contain Ni nor Co.

A pelletizing process of cleaning, drying and pelletizing the admixture may be conducted.

Then, a calcinating process of calculating the pelletized synthetic product by heating the admixture for about 10 to 14 hours at a temperature of about 850 to 950° C. in an inert atmosphere to obtain powder may be performed.

In a range of calcination temperature and time proposed in the calcinating process for synthesizing the cathode active material, a single-phase material having a space group of Fm-3 m with a cubic structure may be manufactured. On the other hand, when the proposed range of calcination temperature and time is deviated, the cathode active material is not synthesized.

When the cathode active material is prepared, a metal oxide coating layer forming operation of forming a metal oxide coating layer by coating an Li—Mo—O-based coating material on the surface of the prepared cathode active material may be performed.

The metal oxide coating layer forming operation may include forming the metal oxide coating layer by coating the Li—Mo—O-based coating material by using a Na₂MoO₄ material in the form of an island on the surface of the cathode active material.

For example, the metal oxide coating layer forming operation may include mixing an amount of about 2 to 3 wt % of an Na₂MoO₄ material with respect to 100 wt % of the cathode active material and heating a mixture for about 3 to 5 hours at a temperature of about 250 to 350° C. in an inert or reducing atmosphere. Then, by reaction between the remaining lithium on the surface of the cathode active material and an Na₂MoO₄ material, the Li—Mo—O-based coating material may be coated in the form of an island on the surface of the cathode active material. In this case, Mo and O components of the Na₂MoO₄ material may be coated on the cathode active material to form the metal oxide coating layer.

Once the metal oxide coating layer is formed, a carbon coating layer forming operation of forming a carbon coating layer by coating the pitch carbon on the surface of the cathode active material may be performed.

The forming the carbon coating layer may include mixing an amount of about 2.5 to 10 wt % of the pitch carbon with respect to 100 wt % of the cathode active material and heating the mixture for about 3 to 5 hours at a temperature of about 250 to 350° C. in the inert or reducing atmosphere, thereby forming a carbon coating layer in which the pitch carbon is coated in the form of an island on the surface of the cathode active material or is coated in the form of a layer on the surface of the cathode active material and the surface of the metal oxide coating layer.

After the metal oxide coating layer and the carbon coating layer are formed on the surface of the cathode active material, the cathode active material having the metal oxide coating layer and the carbon coating layer coated on the surface thereof may be inserted into a ball milling device with low energy and the ball milling process may be performed at least once, thereby forming a complex having the metal oxide coating layer and the carbon coating layer formed on the surface of the cathode active material.

### EXAMPLE

The present invention will be described based on embodiments and a comparative example.

The current embodiment and the comparative example have been provided to check characteristics of the cathode active material with respect to the amount of coating of the pitch carbon while changing the amount of coating of the pitch carbon.

### Embodiment 1

First, the cathode active material may be synthesized.

To satisfy a Li_{1.25}[Mn_{0.45}Ti_{0.35}]_{0.975}Al_{0.025}O₂ composition with the cathode active material, Li₂CO₃ (4.2341 g, 3-5% excess)+Mn₂O₃ (3.2086 g, manufactured with MnCO₃[MnCO₃ plasticized])+TiO₂ (2.5387 g, Anatase)+Al₂O₃ (0.11883 g) were mixed in a jar having a capacity of 80 ml.

In this case, 10 mm×10 g, 5 mm×20 g, and 1 mm×8 g are put in the ZrO₂ ball, and the ball milling condition was performed at 300 rpm/5 h for 15 minutes in 17 sets each.

After ball milling, a synthetic product synthesized with ethanol was washed and then dried, and was pelletized.

The pelletized synthetic product was plasticized for 12 hours at a temperature of 900° C. in an Ar atmosphere to obtain powder.

Thereafter, for surface modification, a Na₂MoO₄ material was mixed at 2.5 wt % with respect to the cathode active material, and then is thermally processed in an atmosphere of 300° C.-4 h Ar/H₂.

After pitch carbon was mixed at 2.5 wt %, the mixture was thermally processed by Ar/H₂ gas at a temperature of 700° C. for 6 hours.

Then, after secondary carbon ball milling (300 rpm/6 h, 20 sets for 15 minutes each) [active material:Acetylene black=9 wt. %:1 wt. %, ZrO₂ Ball: 10 mm×10 g, 5 mm×20 g, 1 mm×4 g] was performed, tertiary carbon ball milling (300 rpm/12 h, 40 sets for 15 minutes each) and [ZrO₂ Ball: 1 mm×11 g] were performed to obtain the cathode active material.

### Embodiment 2

The cathode active material was obtained in the same manner as the embodiment 1, in which pitch carbon is coated at a rate of 5 wt %.

### Embodiment 3

The cathode active material was obtained in the same manner as the embodiment 1, in which pitch carbon is coated at a rate of 10 wt %.

### Comparative Example

The cathode active material was obtained in the same manner as the embodiment 1, in which the cathode active material was obtained without coating of the pitch carbon.

X-ray diffraction (XRD) analysis, scanning electron microscope (SEM) pictures, and transmission electron microscope (TEM) pictures of cathode materials according to the comparative example and the embodiments 1 to 3 provided as described above have been analyzed and results thereof are shown in the drawings.

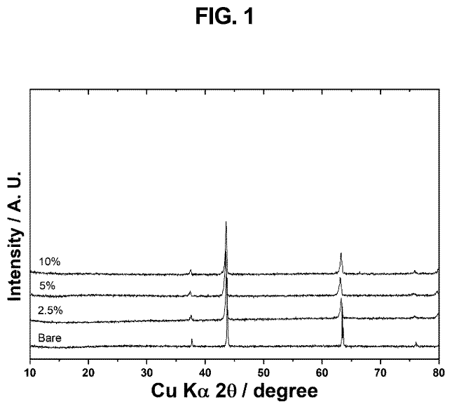

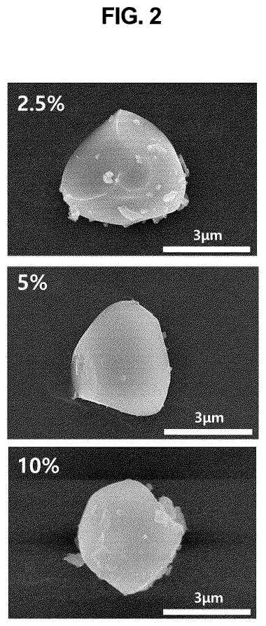

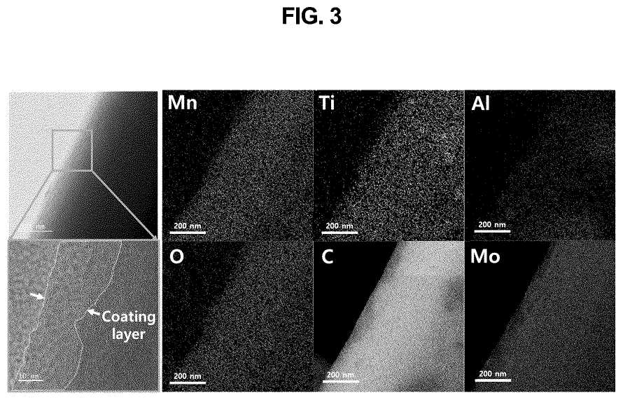

FIG. 1 shows an XRD result of a cathode material for a lithium secondary battery, according to an exemplary embodiment of the present invention, FIG. 2 shows an SEM image of a cathode material for a lithium secondary battery, according to an exemplary embodiment of the present invention, and FIG. 3 shows a TEM image of a cathode material for a lithium secondary battery, according to an exemplary embodiment of the present invention.

FIG. 1 shows XRD results of the comparative example and the embodiments to determine whether a structure is changed due to release of oxygen in a cathode structure according to formation of a carbon coating layer.

As shown in FIG. 1, a peak shape of XRD results of the embodiments 1 to 3 where the pitch carbon was coated by the amount of coating of 2.5 wt %, 5 wt %, and 10 wt %, respectively, was maintained similar to the comparative example Bare where the pitch carbon was not coated.

Based on such results, the coating of the pitch carbon did not affect the crystalline structure of the cathode material.

FIG. 2 shows an SEM image of embodiments to determine whether the surface of the cathode active material is deformed or not according to formation of the carbon coating layer.

As shown in FIG. 2, even when the pitch carbon was coated on the surface of the cathode active material, the surface of the cathode active material was not deformed.

Meanwhile, FIG. 3 shows a TEM image of the embodiment 3 to determine whether the carbon coating layer was formed by coating of the pitch carbon.

As shown in FIG. 3, the carbon coating layer was formed on the surface of the cathode active material to a thickness of 10-25 nm.

Next, electrochemical characteristics according to the provided embodiments and comparative example were measured and a result thereof is shown in the drawing.

First, the electrochemical characteristics of the cathode material will be seen with respect to the amount of coating of the pitch carbon.

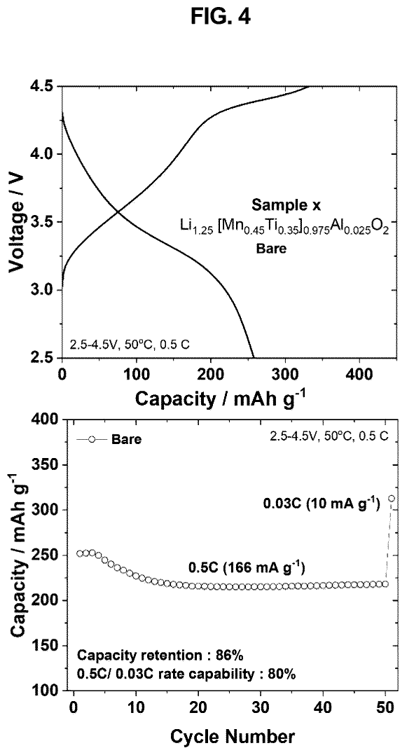

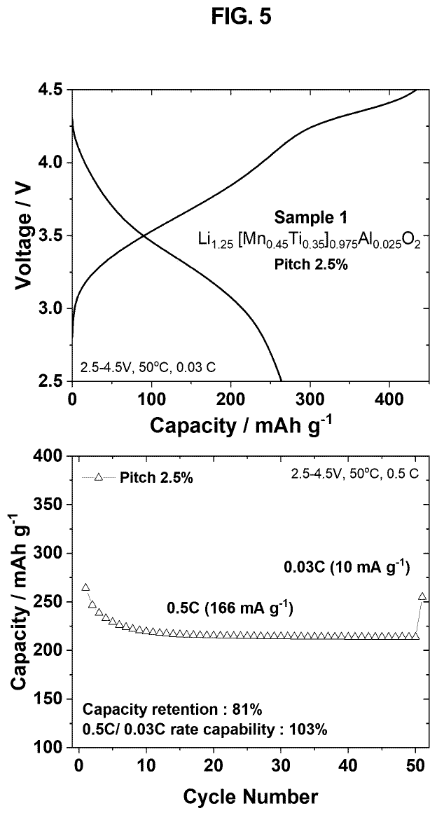

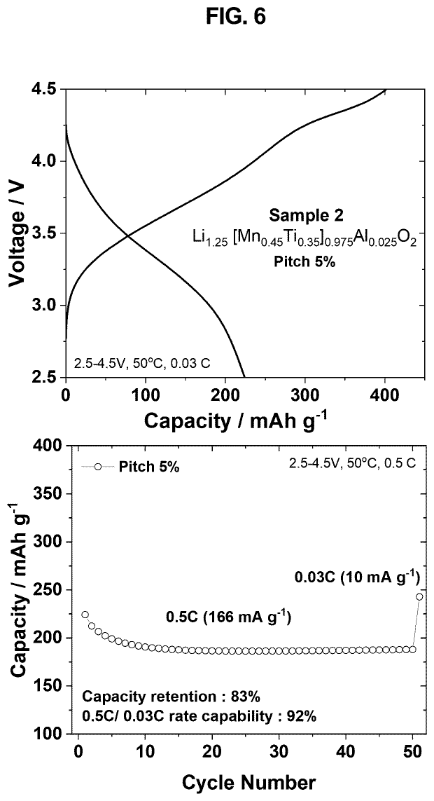

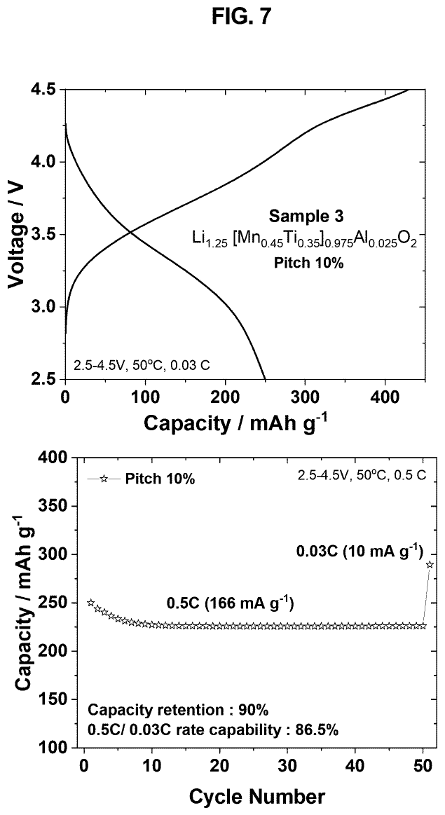

FIGS. 4 to 7 are graphs showing results of evaluating electrochemical characteristics of a cathode material according to the comparative example, the embodiment 1, the embodiment 2, and the embodiment 3, respectively, showing one cycle charging/discharging curve and cycle results of the cathode material.

In the embodiments 1 to 3, according to exemplary embodiments of the present invention, where the pitch carbon is coated at 2.5-10 wt %, when compared to the comparative example, high reversible capacity was seen at similar levels and superior lifetime characteristics are seen.

Thus, when a proper amount of metal oxide coating layer and a carbon coating layer coated with pitch carbon are formed on a cathode active material, high reversible capacity and superior lifetime characteristics are expected.

Next, electrochemical characteristics according to the exemplary embodiments and comparative example with respect to time of exposure to the air are measured and results thereof are shown in the drawings.

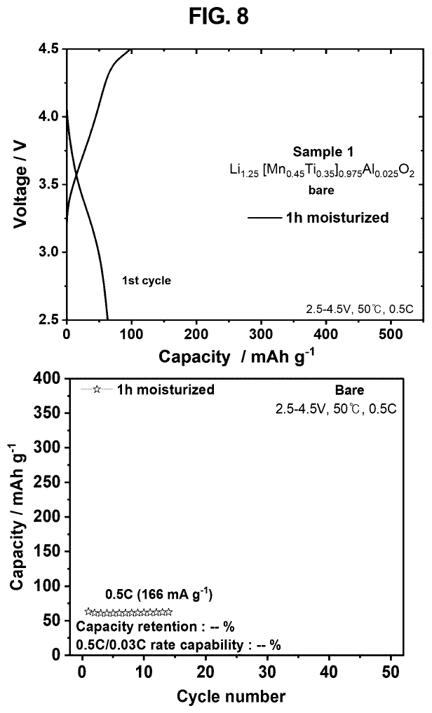

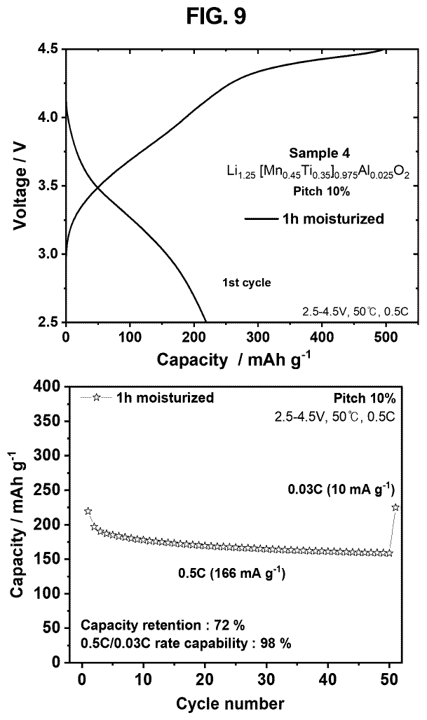

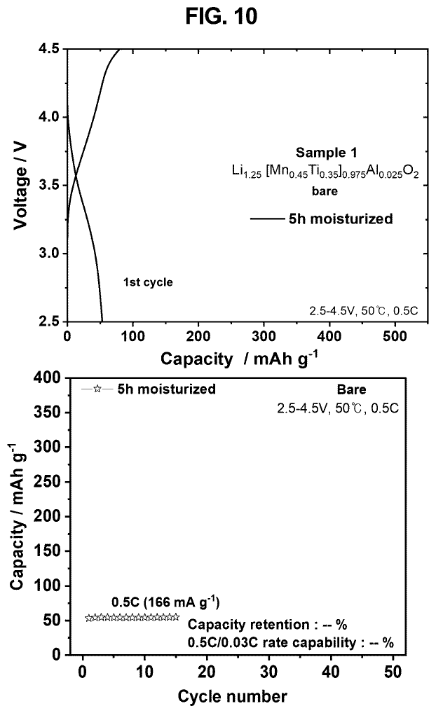

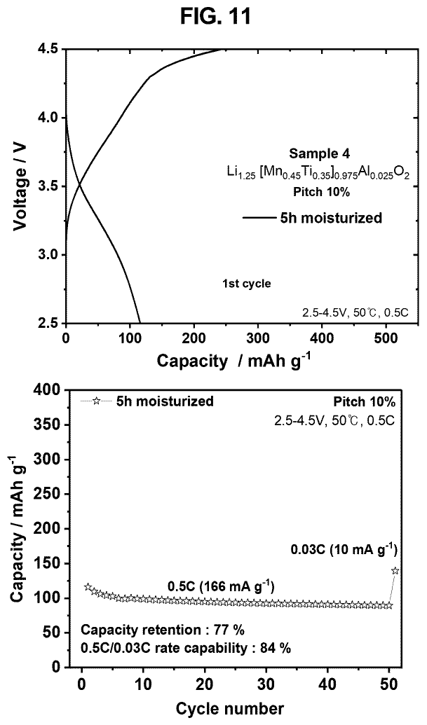

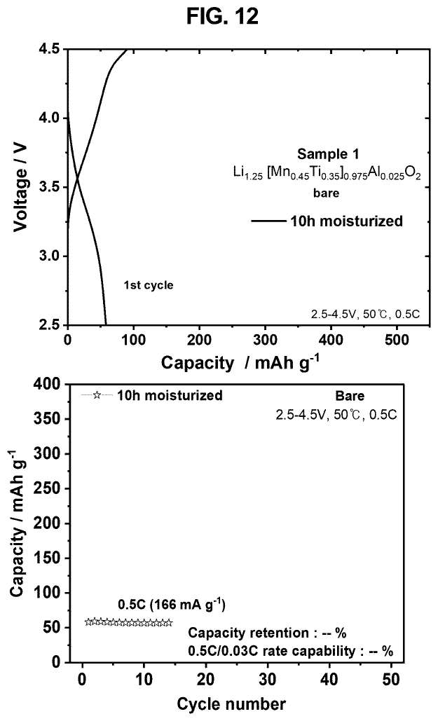

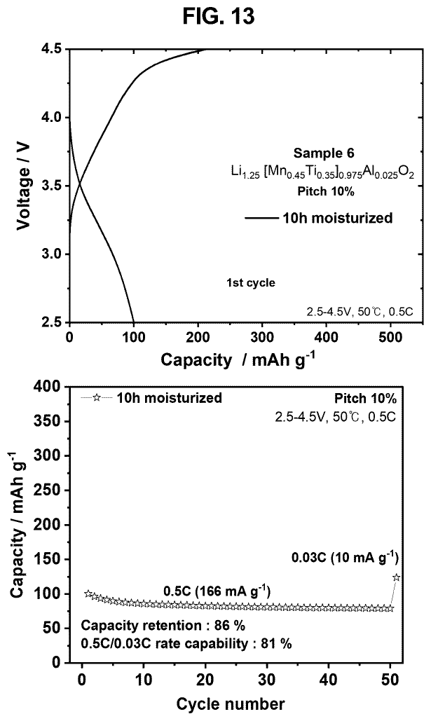

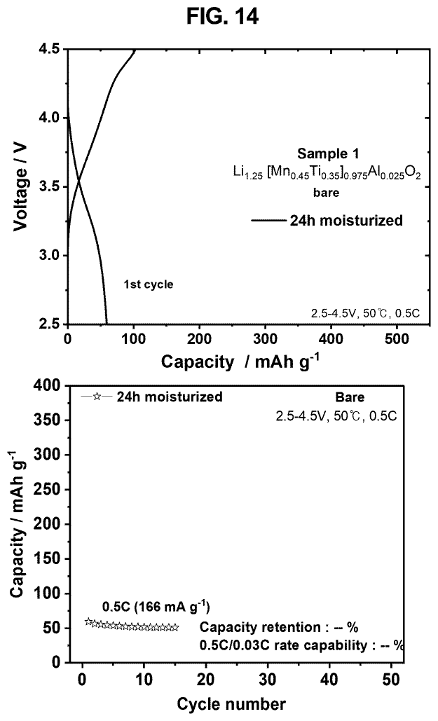

FIGS. 8 to 15 are graphs showing results of evaluating electrochemical characteristics of a cathode material in which the comparative example and the embodiment 1 were exposed to the air for 1 hour, 5 hours, 10 hours, and 24 hours, respectively, in which one cycle charging/discharging curve and cycle results of the cathode material are shown.

In the embodiment 1, according to an exemplary embodiment of the present invention, where the pitch carbon was coated at 10 wt %, when compared to the comparative example, high reversible capacity was seen and, in particular, lifetime characteristics were improved.

Next, an exemplary embodiment of the present invention and the comparative example are exposed to the air and then dried, and electrochemical characteristics thereof with respect to time of exposure to the air were measured and results thereof are shown in the drawings.

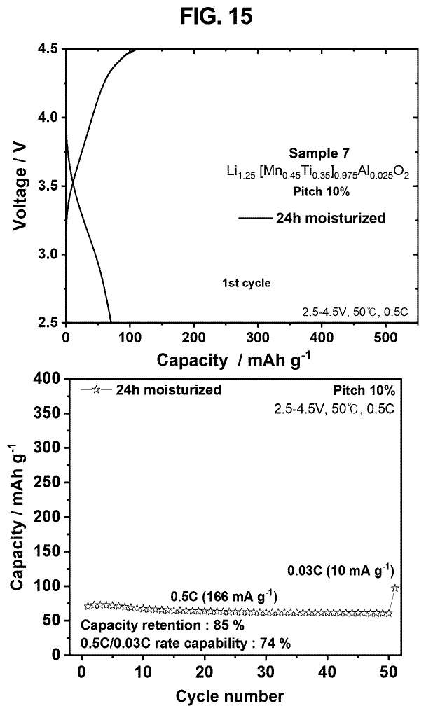

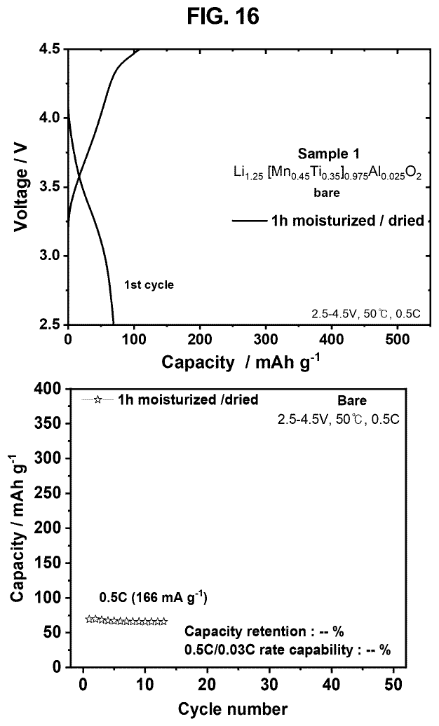

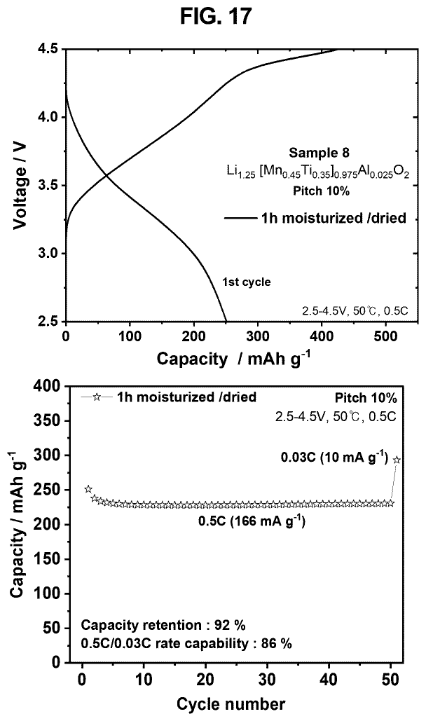

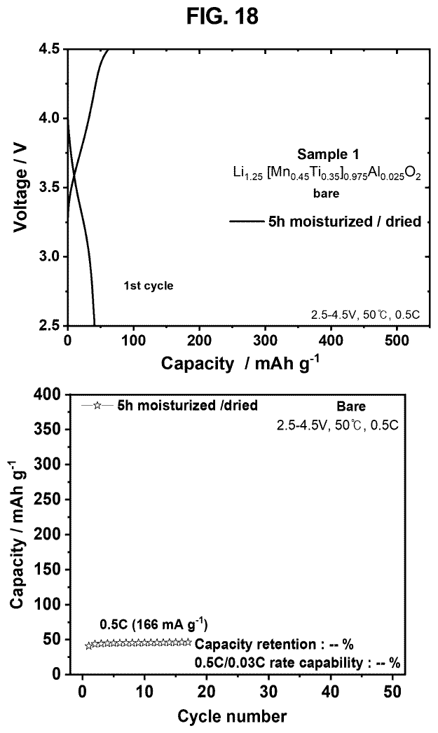

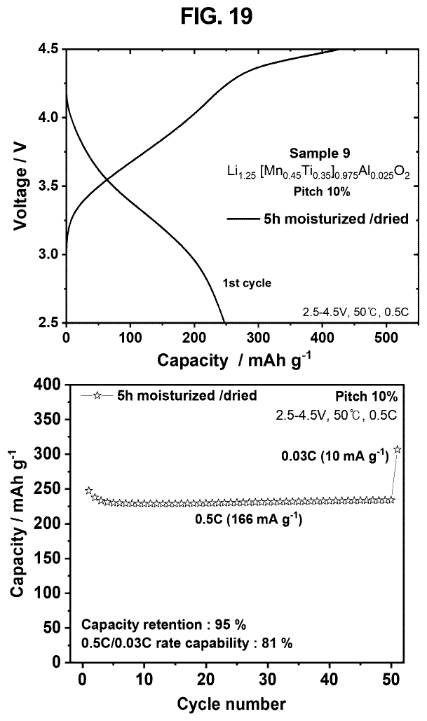

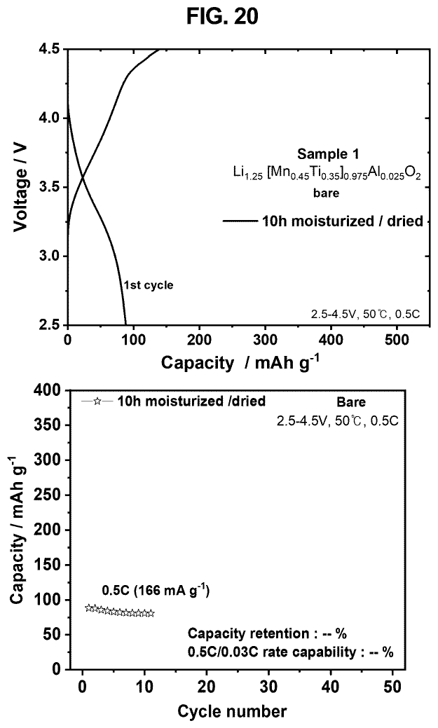

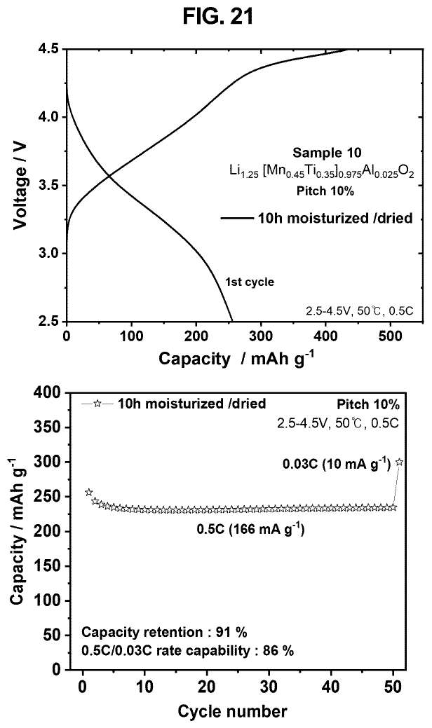

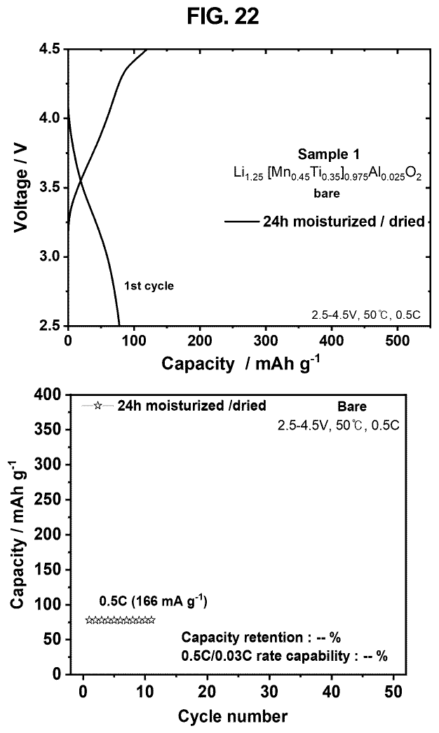

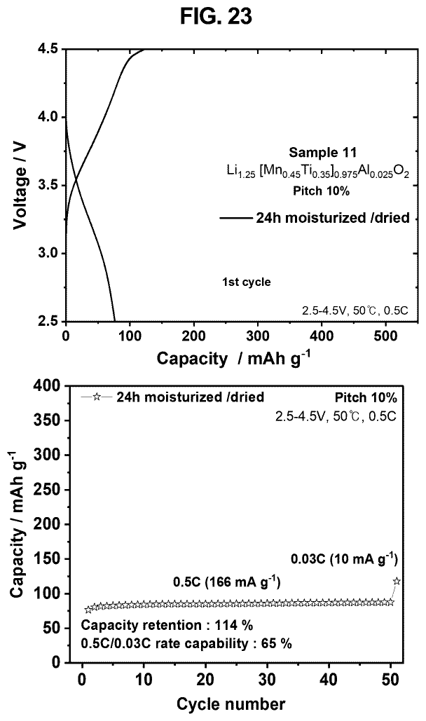

FIGS. 15 to 23 are graphs showing results of evaluating electrochemical characteristics of a cathode material in which Comparative Example and Embodiment 1 were exposed to the air for 1 hour, 5 hours, 10 hours, and 24 hours, and were then dried respectively.

In the embodiment 1, according to an exemplary embodiment of the present invention, where the pitch carbon was coated at 10 wt %, when compared to the comparative example, high reversible capacity was seen and, in particular, lifetime characteristics was improved.

Although the present invention has been described with reference to the accompanying drawings and the above-described exemplary embodiments, the present invention is not limited thereto, but is defined by the following claims. Accordingly, those of ordinary skill in the art may variously change and modify the present invention within the scope without departing from the technical spirit of the claims to be described later.

What is claimed is:

1. A cathode material for a lithium secondary battery, comprising:
a Li—[Mn—Ti]—Al—O-based cathode active material; and
a carbon coating layer comprising pitch carbon and coated on a surface of the cathode active material.

2. The cathode material of claim 1, wherein the carbon coating layer comprises an amount of 2.5 to 10 wt % of pitch carbon with respect to 100 wt % of the cathode active material.

3. The cathode material of claim 1, wherein the cathode active material comprises Li_{1.25+y}[Mn_{0.45}Ti_{0.35}]₁₋ₓAlₓO₂,
in which 0.025≤x≤0.05 and −0.02≤y≤0.02 are satisfied.

4. The cathode material of claim 3, wherein the cathode active material comprises Li_{1.25}[Mn_{0.45}Ti_{0.35}]_{0.975}Al_{0.025}O₂.

5. The cathode material of claim 1, wherein a thickness of the carbon coating layer is about 10 to 25 nm.

6. The cathode material of claim 1, further comprising a metal oxide coating layer in which an Li—Mo—O-based coating material is coated on the surface of the cathode active material.

7. The cathode material of claim 6, wherein the metal oxide coating layer is coated on the surface of the cathode active material in a form of an island, and
the carbon coating layer is coated on the surface of the cathode active material in a shape of an island, or is coated on the surface of the cathode active material and a surface of the metal oxide coating layer in a form of a layer.

8. The cathode material of claim 1, wherein the cathode active material does not comprise Ni nor Co.

9. A method for manufacturing a cathode material for a lithium secondary battery, comprising:
preparing an Li—[Mn—Ti]—Al—O-based cathode active material; and
forming a carbon coating layer by coating pitch carbon on a surface of the cathode active material.

10. The method of claim 9, wherein the cathode active material is prepared by steps comprising:
forming an admixture including Li₂CO₃, Mn₂O₃, TiO₂, and Al₂O₃ in an anhydrous ethanol and processing the admixture using a ball milling;
cleaning, drying and pelletizing the admixture; and
calcinating the pelletized admixture in an inert atmosphere to obtain power.

11. The method of claim 10, wherein the synthetic product synthesized in the synthesizing process comprises Li_{1.25+y}[Mn_{0.45}Ti_{0.35}]₁₋ₓAlₓO₂,
in which 0.025≤x≤0.05 and −0.02≤y≤0.02 are satisfied.

12. The method of claim 11, wherein the admixture comprises Li_{1.25}[Mn_{0.45}Ti_{0.35}]_{0.975}Al_{0.025}O₂.

13. The method of claim 10, wherein the ball milling process is carried out by blending a plurality of ZrO₂ balls having different diameters in a mixed solution in which Li₂CO₃, Mn₂O₃, TiO₂, and Al₂O₃ are mixed in anhydrous ethanol.

14. The method of claim 13, wherein the ball milling process is carried out in 17 sets of about 15 minutes each at about 300 rpm/5 h, by mixing a ZrO₂ ball having a diameter of 10 mm, mixing 20 g of a ZrO₂ ball having a diameter of 5 mm, and mixing 8 g of a ZrO₂ ball having a diameter of 1 mm.

15. The method of claim 10, wherein in the calcinating the pelletized admixture, the synthetic product is heated for about 10 to 14 hours at a temperature of about 850 to 950° C.

16. The method of claim 9, further comprising, before forming the carbon coating layer, forming a metal oxide coating layer in which an Li—Mo—O-based coating material is coated on the surface of the cathode active material.

17. The method of claim 16, wherein the forming the metal oxide coating layer comprises mixing an amount of about 2 to 3 wt % of an Na₂MoO₄ material with respect to 100 wt % of the cathode active material and heating a mixture for 3 to 5 hours at a temperature of about 250 to 350° C.

18. The method of claim 17, wherein forming the metal oxide coating layer comprises performing heating in an inert or reducing atmosphere.

19. The method of claim 9, wherein the forming the carbon coating layer comprises mixing an amount of about 2.5 to 10 wt % of pitch carbon with respect to 100 wt % of the cathode active material and heating a mixture for about 3 to 5 hours at a temperature of about 250 to 350° C.

20. The method of claim 19, wherein the carbon coating layer forming operation comprises performing heating in an inert or reducing atmosphere.
